(19) United States
(12) Patent Application Publication
(10) Pub. No.: US 2009/0277829 A1
(43) Pub. Date: Nov. 12, 2009

(54) Method of ecological restoration of water bodies containing excess nutrient

(76) Inventor: Wenhui He, Shanghai (CN)

Correspondence Address: ZHEN ZHENG LU, 1730 HUNTINGTON DRIVE #304, DUARTE, CA, 91010, US

(21) Appl. No.: 12/122,694

(22) Filed: May 17, 2008

(30) Foreign Application Priority Data
May 7, 2008 (CN) 200810037051.6

(51) Int. Cl. C02F 3/32

(52) U.S. Cl. 210/602; 210/747

(57) ABSTRACT

A method of ecological restoration of water bodies containing excess nutrient includes steps of: (a) taming a kind of plankton to be able to eat blue algae as an algae eating plankton, so as to digest blue algae in the water bodies, and (b) putting the algae eating plankton in the water body polluted by the blue algae, wherein the algae eating plankton eats the blue algae, so that an eco-system of the water body containing excess nutrient can be restored.

### BACKGROUND OF THE PRESENT INVENTION

1. Field of Invention

The present invention relates to a method of ecological restoration, and more particularly to a method of ecological restoration of water bodies containing excess nutrient, comprising a step of putting an organism that can eat blue algae in the water body polluted by the blue algae, so that an eco-system of the water body containing excess nutrients is restored.

2. Description of Related Arts

Many human producing activities discharge waste water rich in nitrogen and phosphorus to the rivers, lakes and so on. Under this situation, the self-purification capacity of water bodies is destroyed, and the nutrient s such as nitrogen and phosphorus accumulate and finally result in an outburst of unicellular algae, especially blue algae, in the water body. The blue algae are mainly aeruginosa. An overrun of the blue algae seriously pollutes the water bodies.

Most of the cells of blue algae have a developed algin layer, and are fully covered by a thick amylase substance. These algin and amylase are hardly digested by the digestant enzyme of any present organism, especially higher animals. Therefore, the emergence of the blue algae can not become part of food chain in the ecosystem. Domestic and overseas experts in environmental protection and biology try to use higher animals including fish to control the pollution caused by blue algae, but have not got ideal results.

Doubtlessly, adding chemical herbicide and flocculants in the water can kill the blue algae instantly. Chemical method is the easiest method to solve the problem, but the chemical and the catabolite finally run up to human bodies via the food chains. What's more important is that chemical treatment can not fundamentally solve this problem of eutrophication. Once the chemicals are decomposed and diluted, the algae will propagate again, and a constant chemical treatment is required.

When dissolved oxygen in water is high in value, the phosphate always crystallizes and becomes a chemical form; when dissolved oxygen in water is low in value, the phosphate will be dissolved in the water, so that charging gas to increase the oxygen content in water can reduce the solubility of phosphate so as to restrain the propagation of algae. In the process of the comprehensive biological management of the water containing excess nutrient, increasing oxygen to water is very helpful. However, only increasing oxygen can not solve the problem of eutrophication in water, the propagation of the algae is still inevitable for the nutrient recycle in the long run.

Microbiological preparation can improve the microbes in the water and substrate silt, and decompose and mineralize the organic matter and nutrients, so as to stabilize some nutrients in inertia form temporarily. The result is similar to the method of increasing oxygen. It is worth mentioning that the living of the microbes depends on the environment and demands absolute dominate populations. Generally, the microbe method may keep good operation status for 15-30 days. Once the conditions change, including climate, substrate, and various water qualities: dissolved oxygen, PH value, temperature and so on, more microbes need to be added continually, or outburst of blue algae may be more serious.

The algae have abundant nutrition and can decompose quickly, so that they are fine organic fertilizer. However, from the commercial perspective, the cost of fetching the algae is much higher than the algae being the organic fertilizer.

As we all know, aquatic plants, such as hyacinth, aquatic peanut, aquatic lotus, aquatic vegetables and aquatic flowers, do absorb nutrient in water, however they also cover the surface of lakes and blot out sunshine, which will lead some living creatures under water and silt, especially some deepwater plants to die, and what's more, will lead the nutrient in the silt to dissolve. Therefore, the disadvantages brought by aquatic plant far exceed the advantages.

### SUMMARY OF THE INVENTION

A main object of the present invention is to provide a method of ecological restoration of water bodies containing excess nutrient, comprising a step of putting an organism that can eat blue algae in the water body polluted by the blue algae, so that an underwater eco-system of the water body containing excess nutrients is restored.

Another object of the present invention is to provide a method of enabling a kind of plankton to be able to eat blue algae, so as to restore an underwater eco-system of the water bodies polluted by blue algae.

Another object of the present invention is to provide a method of ecological restoration of water bodies containing excess nutrition, wherein the nitrogen and phosphorus are transferred to a higher animal by food chain, and the higher animal is caught out of the water so as to realize a balance of the eco-system.

Another object of the present invention is to provide a method of ecological restoration of water bodies containing excess nutrients, which can quickly clean the severely and constantly polluted water bodies by excess nutrients, so as to restore the eco-system of the water bodies.

Another object of the present invention is to provide a method of ecological restoration of water bodies containing excess nutrients, which will not cause new pollution and any negative effect.

Accordingly, in order to accomplish the above object, the present invention provides a method of ecological restoration of water bodies containing excess nutrients further comprises steps of:

(a) taming a kind of plankton to be able to eat blue algae as an algae eating plankton, so as to digest blue algae in the water bodies, and

(b) putting the algae eating plankton in the water body polluted by the blue algae, wherein the algae eating plankton eats the blue algae, so that an eco-system of the water body containing excess nutrient can be restored.

These and other objectives, features, and advantages of the present invention will become apparent from the following detailed description, the accompanying drawings, and the appended claims.

### DETAILED DESCRIPTION OF THE IMPLEMENTATION METHODS

A method of ecological restoration of water bodies containing excess nutrient according to a preferred embodiment comprises steps of.

(a) taming a kind of plankton to be able to eat blue algae as an algae eating plankton, so as to digest blue algae in the water bodies, and

(b) putting the algae eating plankton in the water body polluted by the blue algae, wherein the algae eating plankton eats the blue algae, so that an eco-system of the water body containing excess nutrient can be restored.

We all know that no present plankton is capable of digesting blue algae, so that in step (a), a kind of plankton is tamed to be able to eat and digest the blue alga, which is explained hereinafter. It is worth mentioning that the plankton of the preferred embodiment is Daphnia magna, wherein the step (a) comprises a step of: (a1) improving an intestinal microorganisms composition of the Daphnia magna, so as to enable the Daphnia magna to digest the blue algae.

The step (a) further comprises a step of: (a2) improving field stability of the Daphnia magna, so as to enable the Daphnia magna to be living in the field and to control a growth of the blue algae. The step (a) further comprises a step of: (a3) improving anti-toxic ability of the Daphnia magna, so as to enable the Daphnia magna to survive the toxin of the blue algae.

Further more, the step (a) further comprises a step of: (a4) improve a size of the Daphnia magna, so as to enable the Daphnia magna to eat nodular blue algae. The nature Daphnia magna is 2-4 mm long in average. But by step (a3), the length of Daphnia magna is improved to 4-6 mm. the longer of the Daphnia magna, the more capability the Daphnia magna have to eat nodular blue algae.

In step (a) of the present invention, the tamed Daphnia magna is called “algae eating plankton”. By a process of taming, purifying, rejuvenating, the Daphnia magna only digest the blue algae.

It is worth mentioning that the Daphnia magna produce a weakly acidic excretory product that lower the PH value of the water body, which is capable of controlling the growth of the blue algae, because the outburst of the blue algae needs high PH value. An experiment proves that the weakly acidic excretory product of the blue is algae lowers the PH value of the water body from PH 8.0-9.5 to PH 6.5-8.0.

In step (b), a density of the algae eating plankton put in the water body is 2-6 piece per liter, or 5-10 kilogram per 666.67 square meters. It is worth mentioning that in the present invention, when the density of algae eating plankton is 60-100 per liter, the best eating result can be got. The transparent degree is improved from 30-50 cm to 100-150 cm, after algae eating plankton eat the algae.

Using algae eating plankton to control the water pollution does not need any huge investment, electricity power, or any chemical agent. The method only utilizes a food chain between the creatures, forming a healthy ecosystem.

The method of ecological restoration of water bodies containing excess nutrient according to a preferred embodiment further comprises a step of: (c) planting submerged plant in the water, wherein the submerged plant includes submerged forest and submerged turf.

In winter, the submerged forest mainly includes Potamogeton crispus. And in summer, the submerged forest mainly includes Vallisneria spiralis, Vallisneria spinulosa, Ottelia alismoides, Potamogeton malaimus, Potamogeton pectinatus, Polamogeton maackianus, Batrachium trichophyllum, Myricphyllum spicatum.

In winter, the submerged turf mainly includes Elodea Canadensis. And in summer, the submerged turf mainly includes Hydrilla verticillata, Chara, Najas minor, Najas major, Ceratophyllum demersum.

The coverage rate of the submerged plant in winter of the method is 25-30%, and in summer the coverage rate of the submerged plant of the method is 40-60%. The coverage rate can be adjusted according to the pollution degree.

After the blue algae are eaten, the transparent degree of water body is increased. The sunshine can radiate to the bottom of the water, so as to foster a growth of the submerged plant. The algae eating plankton not only eats algae, but also the suspending substance, including algae, organic detritus, suspending bacteria and mud, so as to greatly improve the transparent degree of the water body.

After the submerged plant is planted, the submerged plant and algae eating plankton are symbiosis in a harmony ecosystem, so that it is easier to architect a landscape under water. The submerged plant not only purifies water, but also forms splendid landscape under water.

It is worth mentioning that the algae eating plankton also produce an excretory product rich in carbon especially DIC (dissolved inorganic carbon), which is important to the growth of the submerged plant, so that in the preferred embodiment, the submerged plant can quickly rebuilt and restored beyond imagination. Experiments prove that the submerged plant grows 2-5 times faster than normal.

Optimize the submerged plant including the submerged forest and submerged turf, by diversifying the plants and enlarging the planting area. The submerged plant substituting single cell algae does photosynthesis under water, and releases a large amount of dissolved oxygen, so as to absorb excess nutrient such as nitrogen and phosphorus, and restrain the growth of single cell algae in the long run. Therefore, the water body containing excess nutrients primarily purifies itself. The submerged macrophytes can also produce some allelochemicals, which can limit the overgrowth of single cell algae.

After step (c) of planting submerged plant in the water, the method of ecological restoration of water bodies containing excess nutrients according to a preferred embodiment further comprises a step of: (d) putting microbes in the water body, wherein the microbes can symbiose with the algae eating plankton.

The microbes diffuse with algae eating plankton to the substrate, and increase the oxidation-reduction potential, which foster the growth of the aquatic insects and aquatic animals. The aquatic insects and aquatic animals in symbiosis system can absorb nutrient in the substrate, so as to purify the water body.

The microbes are widely distributed on the tissue, such as root, stalk, leaf of the submerged macrophytes including submerged forest and submerged turf. The microbes in the water have a denitrifying and dephosphorizing efficiency 3-10 times higher than normal case. The microbes also are capable of fostering a growth of the submerged plants. Therefore, microbes assist a self-purification of the water body.

In step (d), with help of the microbes, the root, stalk, leaf of the submerged macrophytes can convert the 80-89% of the nitrogen into nitrogen gas, and convert the 10-15% of the nitrogen into protein of the submerged plant. And with help of the 25 microbes, the root, stalk, leaf of the submerged plant can convert the 70-76% of the phosphorus into calcium phosphate, and convert the 20-25% of the phosphorus into organic matter of the submerged plant.

The algae eating plankton and microbes can keep the water body transparent for 3-4 months. And when the submerged plant is restored, all plants and animals can keep the water body transparent for decades.

The method of ecological restoration of water bodies containing excess nutrient according to a preferred embodiment further comprises a step of: (e) putting at least one selected from advanced aquatic animals consisting of snail, shellfish, shrimp, fish in the water body. The algae eating plankton and submerge plant can be eaten by the advanced aquatic animals consisting of snail, shellfish, shrimp, fish.

The snail is Radix aitricularia in the preferred embodiment, which can effectively scratch the dust and organic crumb attached on the leaves, so as to enable the submerge plant obtaining more lights to grow healthily. The symbiosis of the living creatures under water increases the oxidation-reduction potential, which fosters the growth of the aquatic insects and aquatic animals, and assists the excess nutrient transfer quickly. The symbiosis system of algae eating plankton and submerge macrophytes will introduce the ecology restoration of all kinds of benthos such as snail, molluscs, aquatic insect et al, and transfers all benthic detritus and algae effectively, Increase the nutrient cycle deeply.

The method of ecological restoration of water bodies containing excess nutrient according to a preferred embodiment further comprises a step of: (f) fishing the finfish and shellfish, for transferring the nitrogen and phosphorus out of water body and keeping balance of the ecosystem in the water body.

The method of ecological restoration of water bodies containing excess nutrient according to a preferred embodiment further comprises a step of: (g) putting carnivorous aquatic animals that can eat advanced aquatic animals, for keeping balance of the ecosystem in the water body.

The method of ecological restoration of water bodies containing excess nutrient according to a preferred embodiment further comprises a step of: (h) when the pollution is getting worse or constant, putting algae eating plankton as emergency, so as to adjust the balance of the ecosystem.

The algae eating plankton, as the most elementary consumer is the bottom of the food chain. All omnivorous animals or flesh-eaters can eat the algae eating plankton, so that the algae eating plankton can be easily eliminated, and won't danger any biologic security. The application of the algae eating plankton to control the blue algae pollution is to transfer the nutrient of nitrogen and phosphorus into the higher animals through food chain, and capture the higher animals out of water, so as to eliminate the nutrient in the water body, and finally restore the ecosystem without second pollution.

The measurement indicates that the algae eating plankton is rich in nutrition, after eating the blue algae, wherein the active substance such as unsaturated fatty acid and amino acid contained in the algae eating plankton is three times of those in meat, 20 times of those in vegetables, so as to provide nutrient for fish, shrimps, crabs and birds, or even to be developed to be Animial Protein Source for human beings.

The method of ecological restoration of water bodies containing excess nutrient of the present invention is not only a method of eating algae, but also a method of leading an explosive ecosystem for the creature of all level.

Finally maintain the ecosystem, add algae eating plankton as emergency, and optimize the biologic species for further lowering the nutrient content in water, after the ecosystem is restored, so as stabilize the quality of the surface water to meet the standard for drinking. The transparency of surface water will reach over 2 meters.

The method of the present invention can ensure the clearance of the algae, nitrogen, phosphorus and COD in the water body. The removal rate of the algae, nitrogen, phosphorus and COD are 99-100%, 90-95%, 80-90%, and 75-80% respectively. After the submerged plant that play a major role for the water-purification is resumed, and the aquatic plants, such as water lilies and lotus, should also be resumed. Further, the original part of the water indigenous aquatic insects, benthic worms, Oligochaete, benthic snail, benthic clam, fish, and part of water fish are resumed. The ecological balance is fully stabilized. And further more, a maintenance and operation criterion for the follow-up ecological balance should be established

One skilled in tie art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of ecological restoration of water bodies containing excess nutrient comprising:
(a) taming a kind of plankton to be able to eat blue algae as an algae eating plankton, so as to digest blue algae in the water bodies, and
(b) putting said algae eating plankton in the water body containing excess nutrition and blue algae, wherein said algae eating plankton eats the blue algae, so that an eco-system of the water body containing excess nutrient can be restored.

2. The method of ecological restoration of water bodies containing excess nutrient, as recited in claim 1, wherein said plankton is Daphinia maglia.

3. The method of ecological restoration of water bodies containing excess nutrient, as recited in claim 2, wherein step (a) comprises a step of: (a1) improving an intestinal microorganisms composition of said Daphnia magnia, so as to enable said Daphnia magna to digest said blue algae in the water body containing excess nutrient.

4. The method of ecological restoration of water bodies containing excess nutrient, as recited in claim 3, wherein step (a) further comprises a step of: (a2) improving field stability of said Daphnia magna, so as to enable said Daphnia magna to be living in field and control said blue algae.

5. The method of ecological restoration of water bodies containing excess nutrient, as recited in claim 4, wherein step (a) further comprises a step of: (a3) improving anti-toxic ability of said Daphnia magna, so as to enable said Daphnia magna to survive a toxin of said blue algae.

6. The method of ecological restoration of water bodies containing excess nutrient, as recited in claim 5, wherein step (a) further comprises a step of: (a4) improve a size of said Daphnia magna, so as to enable said Daphnia magna to eat nodular blue algae.

7. The method of ecological restoration of water bodies containing excess nutrient, as recited in claim 6, wherein in step (b), a density of said algae eating plankton put in the water body is 2-100 piece per liter.

8. The method of ecological restoration of water bodies containing excess nutrient, as recited in claim 6, further comprising a step of: (c) planting a submerged plant in the water body.

9. The method of ecological restoration of water bodies containing excess nutrient, as recited in claim 8, wherein said submerged plant is selected from a submerged forest consisting of Potamogeton malaimus, Vallisneria spiralis, Vallisneria spinulosa, Ottelia alismoides, Potamogeton malaimus, Potamogeton pectinatus, Potamogeton maackiamus, Batrachium trichophyllum, Myricphyllum spicatum.

10. The method of ecological restoration of water bodies containing excess nutrient, as recited in claim 9, wherein said submerged plant is selected from a submerged turf consisting of Elodea canadensis, Hydrilla verticillata, Chara, Najas minor, Najas major, Ceratophyllum demersum.

11. The method of ecological restoration of water bodies containing excess nutrient, as recited in claim 8, wherein a coverage rate of said submerged plant is 25-60%.

12. The method of ecological restoration of water bodies containing excess nutrient, as recited in claim 8, further comprising a step of: (d) putting microbes in the water body, wherein said microbes can symbiose with said algae eating plankton.

13. The method of ecological restoration of water bodies containing excess nutrient, as recited in claim 12, further comprising a step of: (e) putting at least one selected from advanced aquatic animals consisting of snail, shellfish, shrimp, fish in the water body.

14. The method of ecological restoration of water bodies containing excess nutrient, as recited in claim 13, wherein said snail is Radix auricularia.

15. The method of ecological restoration of water bodies containing excess nutrient, as recited in claim 13, further comprising a step of: (f) fishing said advanced aquatic animals, for transferring nitrogen and phosphorus out of the water body and keeping balance of an ecosystem in the water body.

16. The method of ecological restoration of water bodies containing excess nutrient, as recited in claim 13, further comprising a step of: (g) putting higher animals that can eat said advanced aquatic animals, for keeping balance of an ecosystem in the water body.

17. A method of taming Daphnia magna to be able to eat and digest blue algae, comprising a step of: (al) improving an intestinal microorganisms composition of said Daphnia magna, so as to enable said Daphnia magna to digest said blue algae in the water body.

18. The method of taming Daphnia magna to be able to eat and digest blue algae, as recited in claim 17, further comprising a step of: (a2) improving field stability of said Daphnia magna, so as to enable said Daphnia magna to be living in field and control blue algae.

19. The method of taming Daphnia magna to be able to eat and digest blue algae, as recited in claim 18, further comprising a step of: (a3) improving anti-toxic ability of said Daphnia magna, so as to enable said Daphnia magna to survive a toxin of said blue algae.

20. The method of taming Daphnia magna to be able to eat and digest blue algae, as recited in claim 19, further comprising a step of: (a4) improve a size of said Daphnia magna, so as to enable said Daphnia magna to eat nodular blue algae.
